(19) United States
(12) Patent Application Publication
(10) Pub. No.: US 2002/0184417 A1
(43) Pub. Date: Dec. 5, 2002

(54) Method for data transmission

(75) Inventors: Chun-Ping Lin, Hsinchu (TW); Tain-Der Yeh, Hsinchu (TW)

Correspondence Address: BACON & THOMAS, PLLC, 625 SLATERS LANE, FOURTH FLOOR, ALEXANDRIA, VA, 22314

(73) Assignee: Winbond Electronic Corp., Hsinchu (TW)

(21) Appl. No.: 10/006,711

(22) Filed: Dec. 10, 2001

(30) Foreign Application Priority Data
Jun. 1, 2001 (TW) 90113295

(51) Int. Cl. G06F 13/12

(52) U.S. Cl. 710/74

(57) ABSTRACT

A method for transmitting a data to a rewritable nonvolatile memory through an interface port of a computer is proposed. The method comprising steps of: detecting the interface port; transmitting the data through the interface port of the computer; transmitting a part of the data; checking the part of the data for finding a miss condition; and transmitting the part of the data to the rewritable nonvolatile memory again according to the miss condition.

### FIELD OF THE INVENTION

The present invention is related to a method for data transmission, and more particularly to download data from a computer to a rewritable nonvolatile memory by way of detecting a computer communication interface.

### BACKGROUND OF THE INVENTION

The flash memory having wide applications is a sort of rewritable nonvolatile memory. For example, some current toys use a flash memory for storing the function code of sounding, lighting and vibration so shat the toys can attain the amusement effect with some buttons or mechanisms.

Due to the feature on writing repeatable, the effect of sound, light and vibration of the toys can be changed by way of updating the driving program stored in the flash memory. The toys will be animated by the new driving program, so that the toys may be always interesting to the user, therefore the lifecycle of the toys may be longer.

FIG. 1 shows the conventional flowchart for updating the driving program of the toy. When the user updates the driving program, he must plug in a connector (for example RS232 connector) to the computer, then download the driving program from a web site or other media to the flash memory inside the toy. Before writing the driving program into the flash memory, all the data or the programs in the flash memory must be erased.

The conventional method has following disadvantages:

1. The connector cannot be detected by the toy. The user must know that his computer hardware supports what types of connectors before purchasing such a toy so as to avoid buying a useless toy. For example, the user may purchase a toy supporting the USB port to download the updated program, but he doesn't know his computer hardware equips no USB port, so it results the inconvenience of the user. To the toy maker, it is not positive.

2. Before updating the driving program, all data in the flash memory must be erased, but sometimes that may be updated only is a part of the driving program. To erase and write on the flash memory always needs much time, so the conventional method is not efficient.

3. The conventional method lacks the function of error detection, so that the data writing into the flash memory may be not complete due to the miss operations or the wiring problems. This can't be found until the user to play the toy. A user having experience may be download the driving program again, but the user unfamiliar to the toy may misconceive the toy is damaged. If the function of error detection is designed to recover the data or make a warning, the toys will be marketable.

### SUMMARY OF THE INVENTION

An object of the present invention is to provide a transmission method for auto-detecting the connector types in order to promote the system compatibility.

Another object of the present invention is to provide a transmission method for locally erasing and writing the flash memory.

Another object of the present invention is to provide functions of error detection and data recovery for the products whose driving program may be updated, for example the toys mentioned.

According to the present invention, a method for transmitting a data to a rewritable nonvolatile memory through an interface port of a computer, the method comprising steps of: detecting the interface port; transmitting the data through the interface port of the computer; transmitting a part of the data; checking the part of the data for finding a miss condition; and transmitting the part of the data to the rewritable nonvolatile memory again according to the miss condition.

In accordance with one aspect of the present invention, the computer is connected to an internet.

In accordance with one aspect of the present invention, the interface port includes a serial port and a parallel port.

In accordance with one aspect of the present invention, the serial port includes a RS-232 port and a USB port.

In accordance with one aspect of the present invention, detecting the parallel port includes detecting uni-direction, bi-direction, ECP and EPP.

In accordance with one aspect of the present invention, detecting the serial port includes detecting a baud rate.

In accordance with one aspect of the present invention, the rewritable nonvolatile memory is a flash memory.

In accordance with one aspect of the present invention, the flash memory is a serial flash memory.

In accordance with one aspect of the present invention, the flash memory supports a local erasing and a local writing.

In accordance with one aspect of the present invention, checking the part of the data is a method of check sum.

According to the present invention, a method for transmitting a data of an internet to a rewritable nonvolatile memory through an interface port of a computer, the method comprising steps of: connecting a connector to the interface port of the computer; detecting the interface port; and driving the computer to download the data of the internet into the rewritable nonvolatile memory.

In accordance with one aspect of the present invention, includes steps of: checking a part of the data during downloading the data for finding a miss condition; and transmitting the part of the data to the rewritable nonvolatile memory again according to the miss condition.

In accordance with one aspect of the present invention, checking the part of the data is a method of check sum.

In accordance with one aspect of the present invention, the interface port includes a serial port and a parallel port.

In accordance with one aspect of the present invention, the serial port includes a RS-232 port and a USB port.

In accordance with one aspect of the present invention, detecting the parallel port includes detecting uni-direction, bi-direction, ECP and EPP.

In accordance with one aspect of the present invention, detecting the serial port includes detecting a baud rate.

In accordance with one aspect of the present invention, the rewritable nonvolatile memory is a flash memory.

In accordance with one aspect of the present invention, the flash memory is a serial flash memory.

In accordance with one aspect of the present invention, the flash memory supports a local erasing and a local writing.

The present invention may best be understood through the following description with reference to the accompanying drawings, in which:

### BRIEF DESCRIPTION OF THE DRAWINGS

FIG. 1 is a conventional data transmission flow chart for updating the driving program of a toy.

FIG. 2 is a system schematic diagram according to the present invention;

FIG. 3 is a hardware block diagram according to the present invention;

FIG. 4 is a control flow chart of interface port according to the present invention; and

FIG. 5 is a data transmission flow chart for updating the driving program of the flash memory according to the present invention.

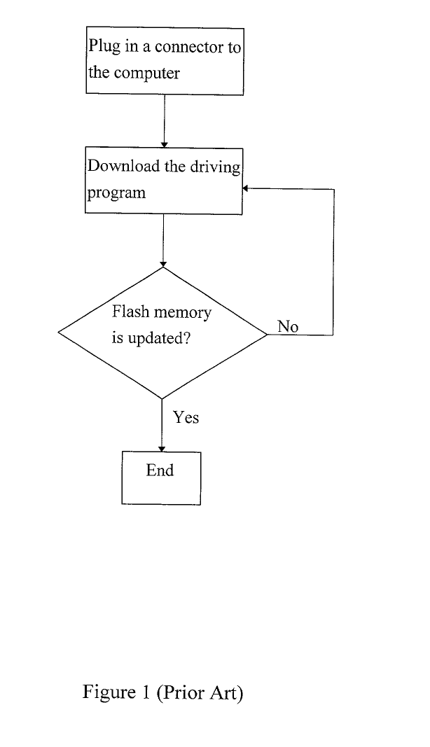

### DETAILED DESCRIPTION OF THE PREFERRED EMBODIMENT

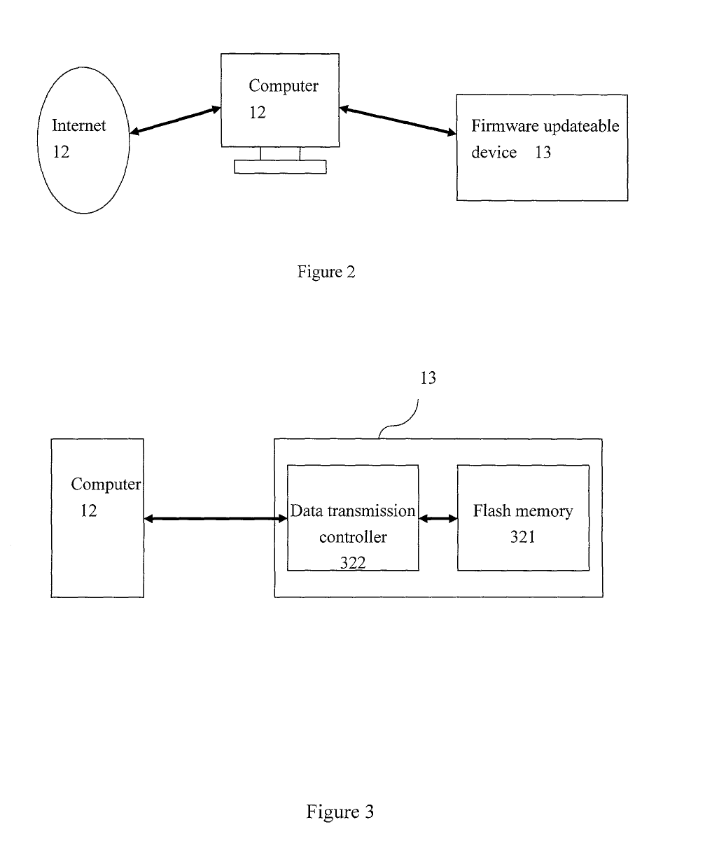

Please refer to FIG. 2 showing the system schematic diagram. The data transmision method according to the present invention can be implemented into the firmware updateable device 13. The firmware updateable device 13 can be connected to a computer 12, and the computer 12 is connected into the internet. When the firmware updateable device 13 is connected to the computer 12, a driving program may be executed for driving the computer 12 connect to the internet and downloading the new version program. For example, the mentioned toy can download the new program to vivify the toy itself by this way.

FIG. 3 shows the hardware hardware block diagram according to the present invention. The device 13 which is firmware updateable includes a data transmission controller 322 and a flash memory 321. When the device 13 connects to the computer, the data in the computer or on the web site can be downloaded into the flash memory 321 of the device 13. After the program or data of the divice 13 is updated, the device 13 may own the new function to perform the best working mode or the best operation effect. For example, the toy updated a new driving program may play the newest sounding, lighting and vibrating effects.

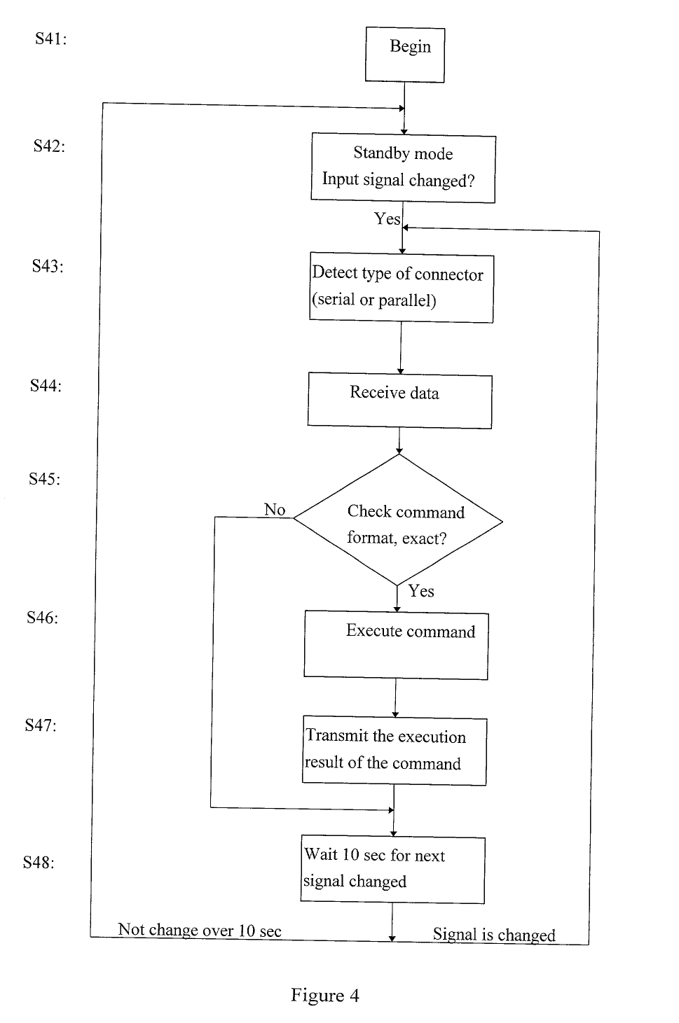

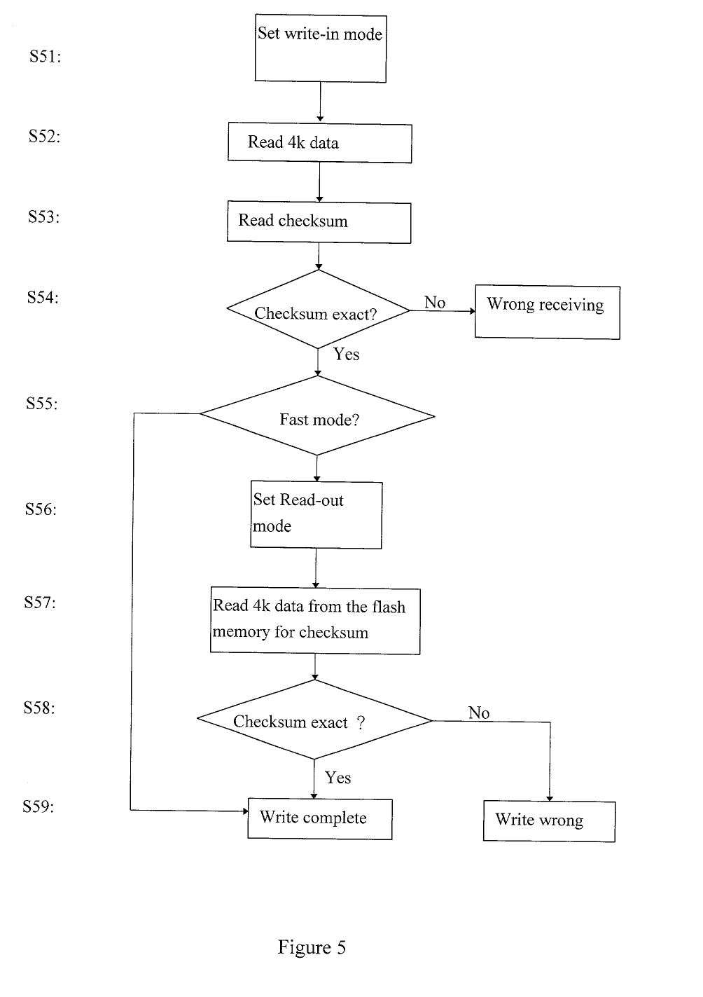

FIG. 3 showing the data transmission controller 322 is the main application of the present method. The data transmission controller 322 may handle the computer 12 and the flash memory 321. The relative flowcharts are illustrated in FIG. 4 and FIG. 5.

FIG. 4 is the control flowchart to the interface port, including following steps.

S41: Begin. The initialization of the data transmission controller may be executed.

S42: Enter the standby mode. The user may plugs the connector of the device 13 which is firmware updateable in the computer for obtaining the newest version software. Whe the device is plugged in, the data transmission controller will detect the change of the status of the input signal. If the status of the input signal is not changed, that represents the connector is not plugged in, so the standby mode is remained.

S43: If the connect is plugged in, the data transmission controller will detect the types of the connector, then the data transmission will work with the specific communication method of the connector. If the RS232 connector is detected, the data transmission will work with the protocol of RS232. In the same, the parallel ports or the USB port may be detected and communicated. The parallel data transmission may be sorted as uni-direcion, bi-direction, ECP, EPP, etc. The data transmission controller may detect the variety of connectors and communicate with each connector.

S44: After the transmission interface port is detected, the data may be transmitted with the indicated connector.

S45: before receiving the data, a command may be sent for telling the computer the length of data or the baud rate of the transmission. Therefore, a piece of data may be checked to confirm whether it is a command format or not.

S46: If a command is found, the decode to the command will be performed. The commands have many kinds, so a command may be executed after the command are decoded.

S47: The execution result will be sent to the computer, and the next command may be waited for or the ending process may be executed.

S48: Wait for the change of the next signal ten seconds. If the signal is always no response or changed during this ten seconds, then go to S42 for standby. If the signal have response, go to S43 for receiving data.

FIG. 5 is the flowchart for the flash memory data transmission, including steps of:

S51: Before writing data to the flash memory, the flash memory must be set into the write-in mode.

S52: Read 4 k data from the computer once.

S53: Check the checksum.

S54: If the checksum is wrong, the data received may have some problems.

S55: If the checksum is right, the data may be writed into the flash memory. After writing data into the flash memory, the fast mode and the typical mode may be choosed. The fast mode will pass the checksum of the 4 k data, and the typical mode must do the checksum process. If the fast mode is set, jump to S59.

S56: If the typical mode is choosed, then set the flash memory as the read-out mode.

S57: Read the 4 k data to check the checksum.

S58: Compare the checksum.

S59: If the checksum is right, the 4 k data writed into the flash memory are accurate. If the checksum is wrong, the 4 k data may have some problems.

The functions to be attained according the present invention are as follows:

1. The computer interface protocol control. When the data is being transmitted, the basis seting of the computer interface may be detected, so the relative protocol or baud rate may by responsed. When the parallel ports are detected by the firmware control program of the data transmission controller 322, the uni-direction, bi-direction, ECP or EPP may be detected. During the detection of the serial port, the baud rate may be detected. Finally, the data transmission may be performed with a suitble firmware program.

2. The data transmission direction control. The data transmission of the control flowchart is bi-directional. The data of the computer can be downloaded to the flash memory and that of the memory can be uploaded to the computer. Speaking to the toy, the download data may be the newest version software, the upload data may be the internal status or the score of the toy.

3. The data serial conversion. When the data of the computer is downloaded, the serial data received by the serial port can be converted into the data format which can be programmed or written into the serial flash memory, or the 4 bits nibble of parallel data received by the parallel port can be converted into the format which can be programmed or written into the serial flash memory.

4. The error detection and data recovery of data transmission. After the data is written into the flash memory, the error can be detected by the CRC checksum of “CCITT Generator Polynomial” CRC-16: xˆ 16+xˆ 12+xˆ 5+1. If the control program finds the checksum error during the download process from the computer to the flash memory, the web site server can be informed to send the data again in order to implement the function of data recovery. During the data transmission, the data block size may be 4 k bits, 8 k bits or 16 k bits. The data may be resent five times. The data transmission will be regarded as failed over five times.

5. The flash memory read&write control. The read&write control of the present invention may be applied to the WINBOND serial flash memory W55Fxx. The flash memory read&write data process is controlled efficiently, so the application to the toys may be utility and convenient.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for transmitting a data to a rewritable nonvolatile memory through an interface port of a computer, said method comprising steps of:
detecting said interface port;
transmitting said data through said interface port of said computer; transmitting a part of said data;
checking said part of said data for finding a miss condition; and
transmitting said part of said data to said rewritable nonvolatile memory again according to said miss condition.

2. A method according to claim 1 wherein said computer is connected to an internet.

3. A method according to claim 1 wherein said interface port includes a serial port and a parallel port.

4. A method according to claim 3 wherein said serial port includes a RS-232 port and a USB port.

5. A method according to claim 3 wherein detecting said parallel port includes detecting uni-direction, bi-direction, ECP and EPP.

6. A method according to claim 3 wherein detecting said serial port includes detecting a baud rate.

7. A method according to claim 1 wherein said rewritable nonvolatile memory is a flash memory.

8. A method according to claim 7 wherein said flash memory is a serial flash memory.

9. A method according to claim 7 wherein said flash memory supports a local erasing and a local writing.

10. A method according to claim 1 wherein checking said part of said data is a method of check sum.

11. A method for transmitting a data of an internet to a rewritable nonvolatile memory through an interface port of a computer, said method comprising steps of:
connecting a connector to said interface port of said computer;
detecting said interface port; and
driving said computer to download said data of said internet into said rewritable nonvolatile memory.

12. A method according to claim 11 wherein includes steps of:
checking a part of said data during downloading said data for finding a miss condition; and
transmitting said part of said data to said rewritable nonvolatile memory again according to said miss condition.

13. A method according to claim 12 wherein checking said part of said data is a method of check sum.

14. A method according to claim 11 wherein said interface port includes a serial port and a parallel port.

15. A method according to claim 14 wherein said serial port includes a RS-232 port and a USB port.

16. A method according to claim 14 wherein detecting said parallel port includes detecting uni-direction, bi-direction, ECP and EPP.

17. A method according to claim 14 wherein detecting said serial port includes detecting a baud rate.

18. A method according to claim 11 wherein said rewritable nonvolatile memory is a flash memory.

19. A method according to claim 18 wherein said flash memory is a serial flash memory.

20. A method according to claim 18 wherein said flash memory supports a local erasing and a local writing.
